(19) United States
(12) Patent Application Publication
(10) Pub. No.: US 2020/0013132 A1
(43) Pub. Date: Jan. 9, 2020

(54) METHOD AND SYSTEM FOR COMPLETING ACTIVITIES AND TRANSACTIONS VIA A GPS LINKED MAP ON A COMMUNICATION DEVICE

(71) Applicants: Eugene P. Benson, Billings, MT (US); Joshua T. Petersen, Vaughn, MT (US)

(72) Inventors: Eugene P. Benson, Billings, MT (US); Joshua T. Petersen, Vaughn, MT (US)

(21) Appl. No.: 16/502,227

(22) Filed: Jul. 3, 2019

Related U.S. Application Data
(60) Provisional application No. 62/694,982, filed on Jul. 7, 2018.

(51) Int. Cl. G06Q 50/26; G06Q 30/00; H04W 4/02; G01S 19/19

(52) U.S. Cl. CPC G06Q 50/26; G01S 19/19; H04W 4/02; G06Q 30/018

(57) ABSTRACT

Embodiments of the invention relate to a method and system for completing activities and transactions via a (GPS) Global Positioning System linked map. The application may be implemented via smart phone application running in a communication device, to allow users to sign in digitally, obtain access to discounts, activities, coupons, payment options using a swipe gesture and/or single or multiple clicks. The GPS system will then navigate the user to selected event, area, coupon or discount etc. The application may be constructed as a two-sided marketplace where local consumers are presented with deals from local or global merchants that meet individual interests.

### CROSS REFERENCE TO RELATED APPLICATIONS

This application claims priority to and the benefit of the filing date of U.S. Provisional Application No. 62/694,982, filed on Jul. 7, 2018 which is hereby incorporated by reference in its entirety.

### BACKGROUND OF INVENTION

Merely by example, the below illustrates how this system and method was developed.

### Block Management (BMA)

Block Management is a cooperative effort between Montana Fish, Wildlife & Parks (FWP), private landowners, and public land management agencies to help landowners manage hunting activities and to provide free public hunting access to private and isolated public lands.

A cooperative program between private landowners and FWP, Block Management helps landowners manage hunting activities and provides the public with free hunting access to private land, and sometimes to adjacent or isolated public lands.

Landowner participation in block management is voluntary. Contracts are negotiated annually in the spring and summer. After enrollment is complete, FWP publishes a Hunter Access Guide, which lists all block management opportunities available to you for the current season.

### Types of Block Management

TYPE I: Areas where hunters administer their own permission, either by using sign-in boxes or rosters or hunting on areas that specify no permission is required See FIG. 1. Typically, Type I BMAs do not limit hunter numbers. See FIG. 2

TYPE II: Areas where someone other than the hunter administers permission, typically with a landowner or FWP employee issuing permission slips. Type II BMAs often use hunter management systems that may limit hunter numbers, require reservations, assign pastures, etc.

Through Block Management, landowners allow public hunters onto their lands. In return, Montana Fish, Wildlife and Parks through fees paid by hunters provides services including enforcement, hunter management and proper signage to help out landowners. Landowners also receive payments to help offset some of the impacts of hunters, including weed management.

For Type I BMA, Hunters administer their own permission, either by using a sign-in box or roster at designated access points. These sign-in boxes are generally located in hard to find areas on the perimeter of the fenced land. See FIG. 3

While hunting in a Type I BMA area we came across a nice buck, unfortunately we were having extreme difficulty locating the sign-in box. This resulted in an immense amount of frustration and an unsuccessful harvest. While returning home we asked ourselves there must be a better way to instantly access Block Management from a communication device without having to search for a sign-in box.

Montana Access™ by Mountainworks Software Inc. is a software program that provides hunters the ability to locate BMA areas, sign-in box location, topographical maps, but does not offer a system of incorporating Artificial Intelligence with GPS.

onXmaps™ is a software program that provides hunters public/private landowner names and boundaries, nationwide topo and aerial private land owner information. Also maps state and federal land, but does not offer a system of incorporating Artificial Intelligence with GPS.

Groupon™ is an e-commerce marketplace that connects subscribers with local merchants by offering activities, travel, goods and services through coupons. Attracts consumers to merchants but does not offer a system combining activities, travel, goods and services by incorporating GPS.

Accordingly, it would be advantageous to provide a method and system to instantly access activities, travel, goods and services within your geographical location without having to physically seek out your interests. Furthermore, because this system is connected to GPS users can set predetermined perimeters for interests and activities. Additionally, the value of using this method and system can benefit the consumer by connecting users' interests and activities which can be accomplished digitally, through a software program that will allow access to Block Management Areas without having to physically seek out the sign-in area. See FIG. 4.

### BRIEF SUMMARY OF THE INVENTION

Embodiments of the invention relate to a method and system for completing activities and transactions via a (GPS) Global Positioning System linked map on a communication device. The application may be implemented via smart phone application running on a communication device, to allow users to sign in digitally, obtain access to discounts, activities, coupons, payment options using a swipe gesture and/or single or multiple clicks. See FIG. 5. The application would be constructed as a two-sided marketplace where local consumers are presented with deals from local or global merchants that meet individual interests using a GPS mapping system. As a value proposition this method and system would attract consumers to merchants by providing consumers with savings, discounts, opportunities and convenience. Consumers will have the ability to access everything from discounts, coupons, ticketing events etc. at the touch/swipe of a screen using single or multiple clicks without having to spend valuable time searching their local area for the things they enjoy. Incorporated within this system and method will be a standard payment processing system where users will have the ability to purchase goods, services, activities by using single or multiple clicks by way of crypto currency, U.S. Currency or otherwise. This new GPS system will allow users to be directly linked to any entity whether private commercial, non-profit or otherwise by panning a GPS region. Some may look at this and think Groupon™ for GPS or Living Social™ for GPS. However one might analogize this, the concept has similarities but is different. This system and method will provide offers to everyone who are panning or searching in a specific area on a GPS mapping system. Embodiments of the subject invention are compatible worldwide to include the United States. The mention of Block Management, Montana Fish, Wildlife and Parks is provided for illustrative purposes only and is not intended to limit the scope of the application.

Embodiments of the invention relate to a method and system for panning across a GPS linked map allowing access with single or multiple click payment system via a communication device. A GPS linked map may be provided and displayed on a communication device of the user with an identifier that identifies the user and the user's location and said interests by way of a drop down menu (see FIG. 6). The user may register account information which may include name, address, phone number, payment information etc. Once registered the user may access the GPS mapping system which is integrated with a panning function (a swipe gesture) that may be displayed on their communication device. This panning function allows user to interact with their communication device, such as (pan) or swipe across the map to a specific area, to see what types of land or activities are available in their area to include: State land, Federal land, Private land, available activities, price, owner/organizer contact information, or any other information. The specific events may be color coordinated when displayed on the communication device. For example: Private land available to hunt may be green, State land yellow, Federal land blue (see FIG. 7). When the user pans across an area and zooms in on a specific region within that area displayed on their communication device, details of the area will automatically generate and be displayed on their communication device that may include: landowner information, price to hunt/fish/camp, or details of specific events available in the area and price to obtain tickets for event (see FIG. 8), or any other information which may be used to complete a transaction or activity. Once the user identifies area requesting to obtain access, user will simply click on the desired area/event displayed on their communication device and transaction may be completed so that the user will be able to access desired property preferably by a click of a button (see FIG. 9). This click of a button (not limited to just one click, system may also have drop down options and the like in which multiple clicks may be needed) will complete a transaction so as to generate payment to landowner/organizer of event. Preferably, the user will have the ability to gain access to property/event/coupon immediately.

This system and method may use Data Intelligence or other data collection techniques to form a better understanding of the information collected to improve the services provided. When collecting data this system and method may look for a variety of sources that include business performance metrics, data mining of consumers and users and other descriptive sources. It will be evident, however, to one skilled in the art that the present invention may be practiced without these specific details.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a Permission slip currently used by the Montana Fish, Wildlife and Parks for Type 1 Block Management.

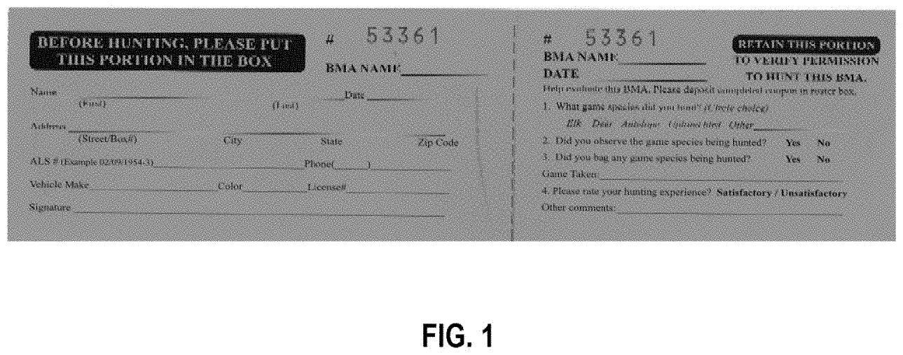

FIG. 2 illustrates a Block Management Sign in Box. (Typically located at hard to find areas) The sign in box is used to house permission slips, (FIG. 1) both complete and incomplete.

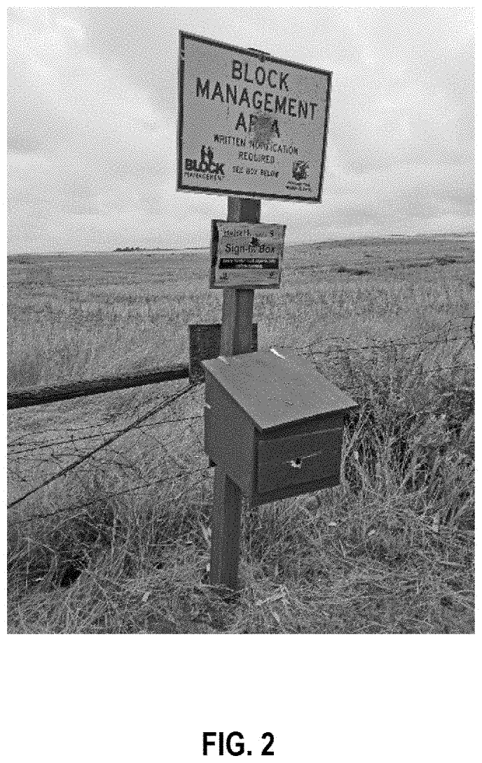

FIG. 3 shows a hunter completing a permission slip via paper and pen at a sign in area.

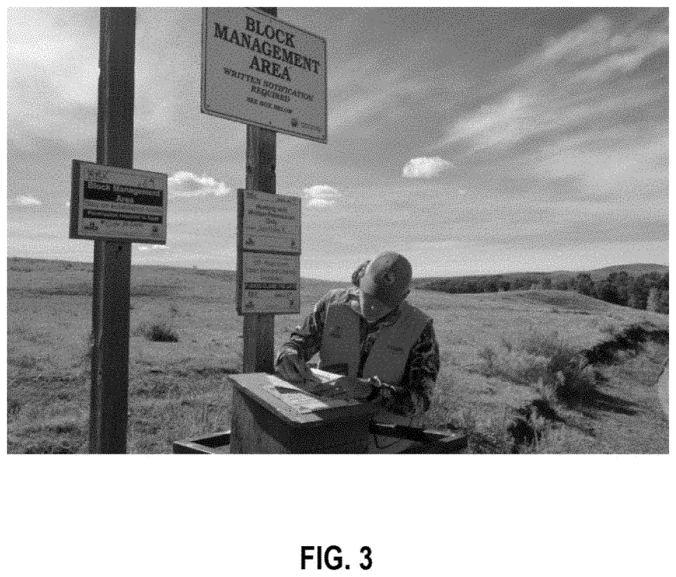

FIG. 4 depicts a prototype map application for the hunting districts in the State of Montana that would be accessible in the application being developed.

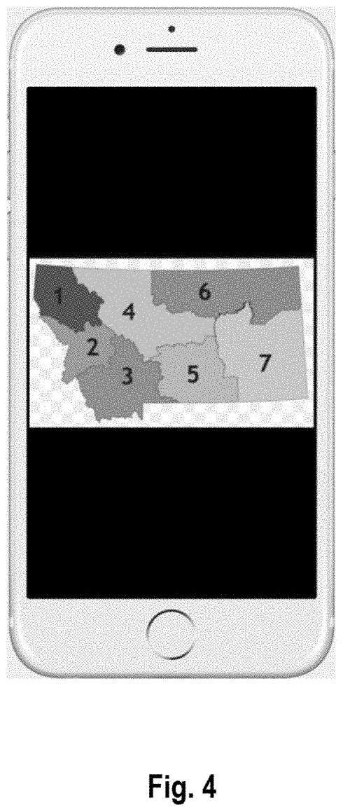

FIG. 5 illustrates a permission slip on a cell phone that may be incorporated within the application to allow hunters to sign into hunting areas.

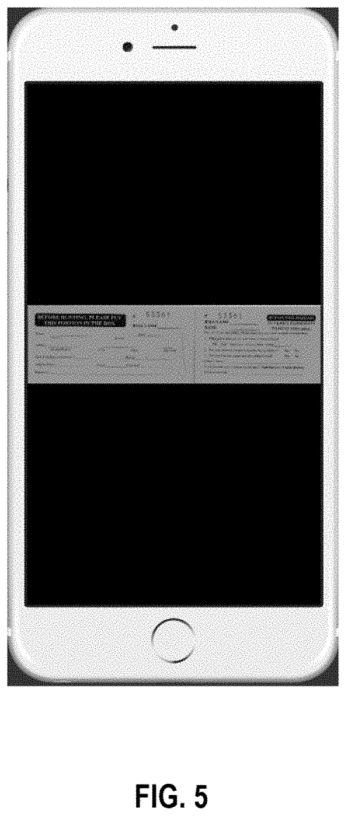

FIG. 6 shows an example GPS map on a communication device (location is automatically generated per user GPS location).

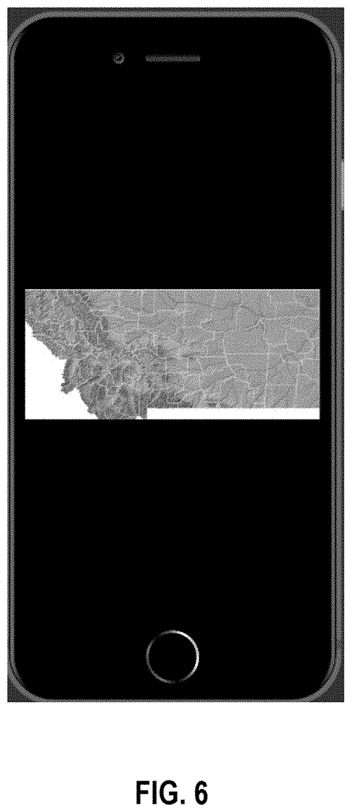

FIG. 7 depicts example Highlighted areas that are available to hunt (hunting was the option the user requested per drop down to generate).

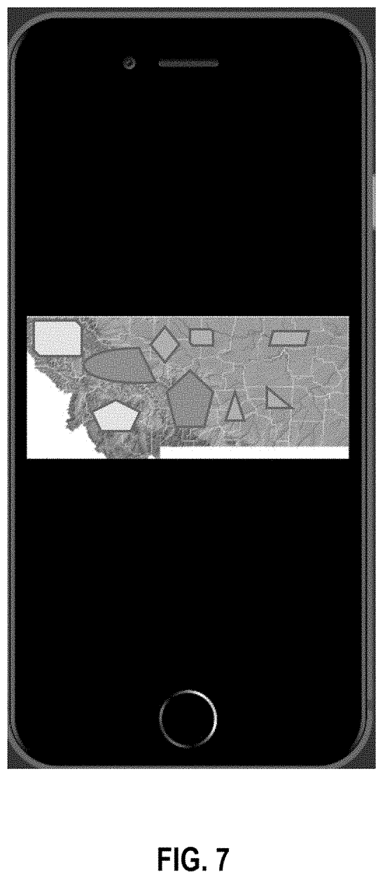

FIG. 8 illustrates an example GPS map of Montana with land/contact/price information when user pans across and zooms into a specific area requesting.

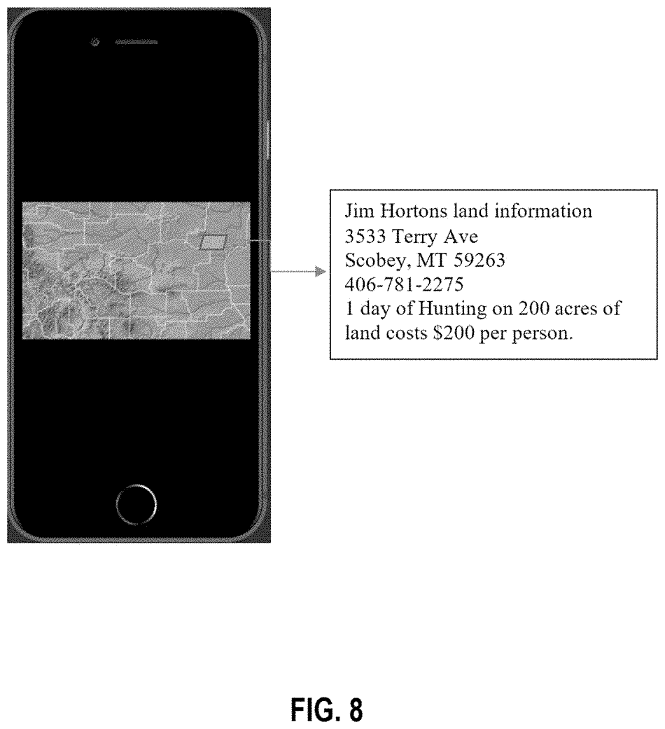

FIG. 9 shows an example Single click payment system and instant access.

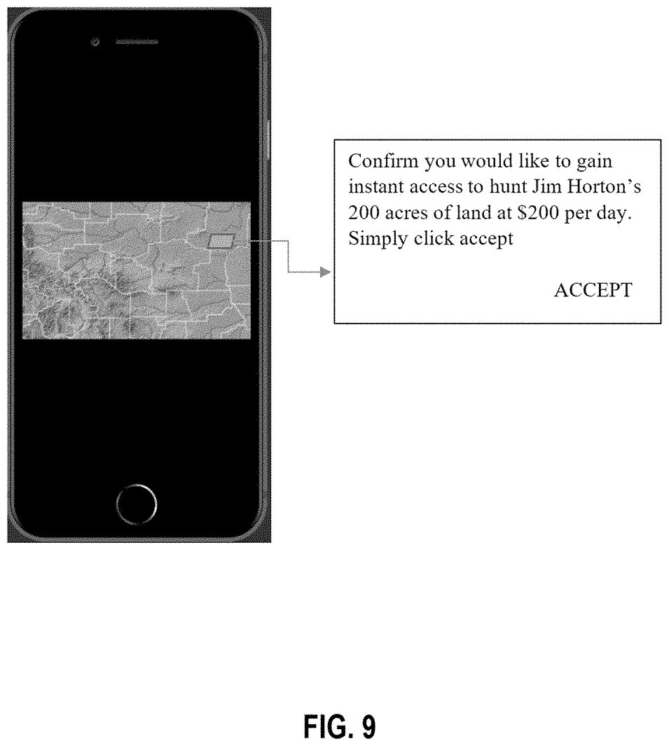

FIG. 10 shows an example of a block diagram of a server which may be used in the system or standalone according to various embodiments described herein.

FIG. 11 shows an example of a block diagram of a communication device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new method and system for completing activities and transaction via a GPS linked map on a communication device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Embodiments of the invention relate to a mobile application, smart phone application, and/or other communication device 4400 application, that allows users, such as hunters/consumers, to more conveniently complete activities and transactions, such as to sign into hunting areas (digitally), and the reports and records of the activities and transactions can be submitted more efficiently (electronically) than the current reporting methods. In some embodiments, the system may comprise a detailed map (OR REFERENCE TO HUNTING AREA) displayed on a communication device 4400 that may be used to allow users to digitally sign into private lands or complete other activities and transactions through the means of an application running on a communication device 4400 and/or server 3300. The application may then send the recorded information electronically to the reporting agency for recording and administrative purposes via a communications network.

Embodiments of the subject invention are compatible worldwide to include the United States. The mention of Hunting is for illustrative purposes only and is not intended to limit the scope of the application.

In some embodiments, once all of the required sign-in information is entered by the user into their communication device 4400 they then have access to the private hunting area or are otherwise able to complete a transaction or activity. The mobile application can then send the sign-in report to the reporting agency. The reporting agency can then upload this data onto their system, thus eliminating the need for agency to visit the site and collect sign in data.

Advantages of the system are that Fish, Wildlife and Parks, and other providers of transactions and activities can save time and money. This system over a period of time may be used eliminate the need to perform transactions and activities at limited geographical locations, such as sign-in boxes, so to no longer require employees of Fish, Wildlife and Parks to physically go collect data from sign-in boxes. Furthermore, it will relieve the hunter and other individuals of the frustration and inconvenience to locate the sign-in box or other transaction or activity completing location. In addition, this system will benefit both consumers and merchants by attracting consumers to merchants. Consumers will have be given opportunity for discounts, activities, goods and services that meet their interests which will drive business to the local or global merchants.

Embodiments of the invention relate to a method and system to pan across a GPS linked map displayed on a communication device 4400 allowing the user to gain access to an area with a single click payment system (optionally multiple clicks). The GPS linked map may show all accessible options for activities and transactions being sought and may be highlighted a particular color according to availability, land type, or activity sought. The user can pan across GPS map displayed on their communication device 4400 and information concerning the area may be generated or displayed on their communication device 4400, such as State land, Federal land, Private land, available activities (hunting, fishing, camping, concerts, etc.) price, owner/organizer contact information or any other information which may be used to complete one or more transactions and activities. Once a user identifies an area displayed on their communication device 4400 requesting to obtain access, the user may simply click on the desired area/event and will be able to complete a transaction or activity, such as to access desired property, by a click of a button displayed on their communication device 4400. This click of a button (not limited to just one click, system may also have drop down options in which multiple clicks may be needed) will allow a transaction or activity to be completed, such as to generate payment to landowner/organizer of event. Preferably, the user may have the ability to gain access to property/event immediately.

Aspects of the invention, such as receiving, processing, and/or sending out information regarding the panning across a GPS map displayed on a communication device 4400 allowing access with single or multiple clicks, may be described in the general context of computer-executable instructions, such as program modules, being executed by a computer, such as a communication device 4400 and/or server 3300. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media that may be performed on one or more communication devices 4400 and/or servers 3300.

The invention may be practiced in distributed-computing environments where tasks are performed by remote-processing devices, such as one or more communication devices 4400 and/or servers 3300 that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network comprising one or more communication devices 4400 and/or servers 3300. Such networks are widely used to connect various types of network elements, such as routers, servers, gateways, and so forth. Further, the invention may be practiced in a multi network environment having various, connected public and/or private networks. It should be understood that the examples and embodiments described herein are for illustrative purposes only and that various modifications or changes in light thereof will be suggested to persons skilled in the art and are to be included within the spirit and purview of this application.

### Example

User downloads the system application on their communication device 4400, registers with the system with required information which may include: Name, Address, phone number, payment details (bank information). This information may be stored in a secure cloud (secure network) or any other location. User may be located in Missoula, Mont. and would like to know what activities/events are in the area. User pulls up application on their communication device 4400. GPS map is displayed on their communication device 4400 automatically and generates to the area the user is at (with the ability to choose other locations). Activities within the area the user is zoomed in on automatically generate (user also has option to select activities of interest from the drop down menu ie. sporting events, concerts, hiking trails, hunting areas, camping areas, fishing areas etc.) and are displayed on their communication device 4400. User chooses concerts within the area via their communication device 4400 that the user would like to attend on a selected date range. All rock and roll concerts within the designated area and date range automatically generate on the math at the user may be interested in that are available and is displayed on their communication device 4400. User may pan across the communication device 4400 screen, zooms in on an area to get specific details concerning the event or concert they are requesting. Once zoomed in, User is able to see details of the concert displayed on their communication device 4400, such as location, price, acceptable payment options etc. If the User decides they would like to attend concert, the user may interact with their communication device 4400, such as by simply clicking on available concert, to accept on the performance and payment may be automatically generated to administrator of event through a third party payment system or directly to event organizer but not limited to, resulting with the user having instant access to concert requesting to attend.

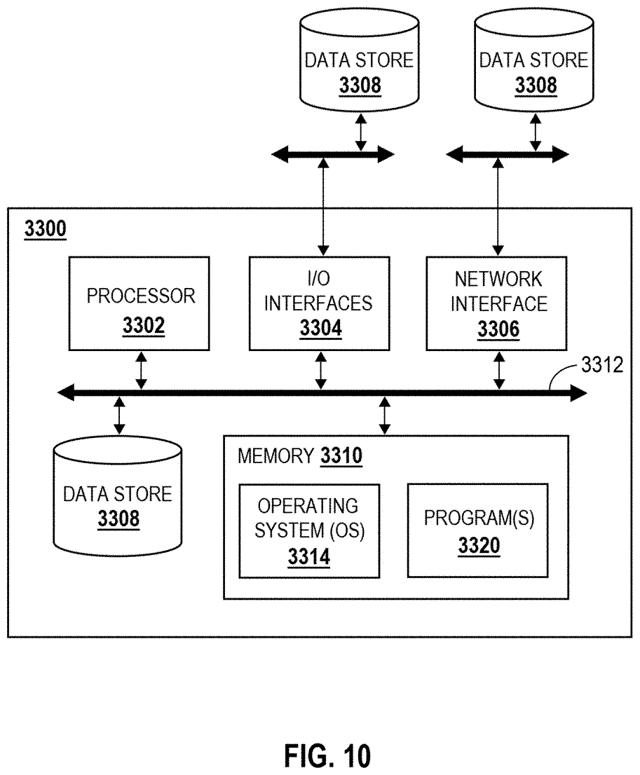

Referring to FIG. 10, in an exemplary embodiment, a block diagram illustrates a server 3300 which may be used in the system, in other systems, or standalone. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 10 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally, in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (O/S) 3314 and one or more programs 3320. The operating system 3314 essentially controls the execution of other computer programs, such as the one or more programs 3320, and provides scheduling, input-output control, file and data management, memory management, and communication control and related services. The one or more programs 3320 may be configured to implement the various processes, algorithms, methods, techniques, etc. described herein.

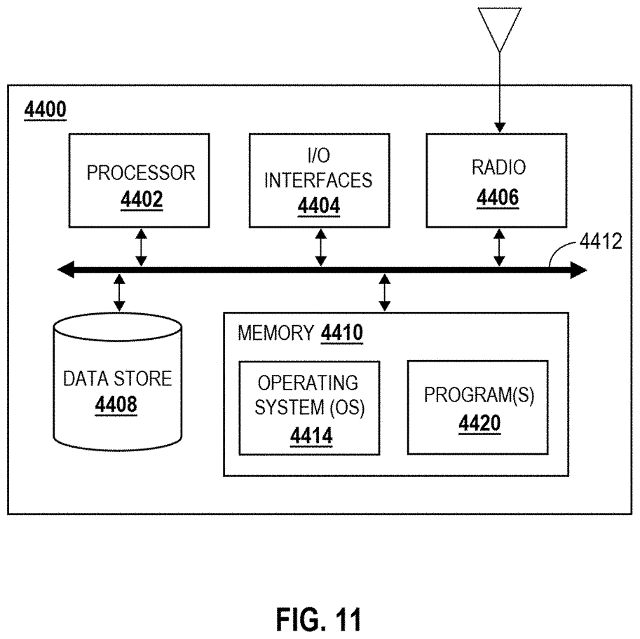

Referring to FIG. 11, in an exemplary embodiment, a block diagram illustrates a communication device 4400, which may be used in the system or the like. The term “communication device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The communication device 4400 can be a digital device that, in terms of hardware architecture, generally includes a processor 4402, input/output (I/O) interfaces 4404, a radio 4406, a data store 4408, and memory 4410. It should be appreciated by those of ordinary skill in the art that FIG. 11 depicts the communication device 4400 in an oversimplified manner, and a practical embodiment may include additional components and suitably configured processing logic to support known or conventional operating features that are not described in detail herein. The components (4402, 4404, 4406, 4408, and 4410) are communicatively coupled via a local interface 4412. The local interface 4412 can be, for example but not limited to, one or more buses or other wired or wireless connections, as is known in the art. The local interface 4412 can have additional elements, which are omitted for simplicity, such as controllers, buffers (caches), drivers, repeaters, and receivers, among many others, to enable communications. Further, the local interface 4412 may include address, control, and/or data connections to enable appropriate communications among the aforementioned components.

The processor 4402 is a hardware device for executing software instructions. The processor 4402 can be any custom made or commercially available processor, a central processing unit (CPU), an auxiliary processor among several processors associated with the communication device 4400, a semiconductor-based microprocessor (in the form of a microchip or chip set), or generally any device for executing software instructions. When the communication device 4400 is in operation, the processor 4402 is configured to execute software stored within the memory 4410, to communicate data to and from the memory 4410, and to generally control operations of the communication device 4400 pursuant to the software instructions. In an exemplary embodiment, the processor 4402 may include a mobile optimized processor such as optimized for power consumption and mobile applications. The I/O interfaces 4404 can be used to receive user input from and/or for providing system output. User input can be provided via, for example, a keypad, a touch screen, a scroll ball, a scroll bar, buttons, bar code scanner, and the like.

System output can be provided via a display device such as a liquid crystal display (LCD), touch screen, and the like. The I/O interfaces 4404 can also include, for example, a serial port, a parallel port, a small computer system interface (SCSI), an infrared (IR) interface, a radio frequency (RF) interface, a universal serial bus (USB) interface, and the like. The I/O interfaces 4404 can include a graphical user interface (GUI) that enables a user to interact with the communication device 4400. Additionally, the I/O interfaces 4404 may further include an imaging device, i.e. camera, video camera, etc.

The radio 4406 enables wireless communication to an external access device or network. Any number of suitable wireless data communication protocols, techniques, or methodologies can be supported by the radio 4406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 4408 may be used to store data. The data store 4408 may include any of volatile memory elements (e.g., random access memory (RAM, such as DRAM, SRAM, SDRAM, and the like), nonvolatile memory elements (e.g., ROM, hard drive, tape, CDROM, and the like), and combinations thereof. Moreover, the data store 4408 may incorporate electronic, magnetic, optical, and/or other types of storage media.

The memory 4410 may include any of volatile memory elements (e.g., random access memory (RAM, such as DRAM, SRAM, SDRAM, etc.), nonvolatile memory elements (e.g., ROM, hard drive, etc.), and combinations thereof. Moreover, the memory 4410 may incorporate electronic, magnetic, optical, and/or other types of storage media. Note that the memory 4410 may have a distributed architecture, where various components are situated remotely from one another, but can be accessed by the processor 4402. The software in memory 4410 can include one or more software programs, each of which includes an ordered listing of executable instructions for implementing logical functions. In the example of FIG. 11, the software in the memory 4410 includes a suitable operating system (O/S) 4414 and programs 4420. The operating system 4414 essentially controls the execution of other computer programs, and provides scheduling, input-output control, file and data management, memory management, and communication control and related services. The programs 4420 may include various applications, add-ons, etc. configured to provide end user functionality with the communication device 4400. For example, exemplary programs 4420 may include, but not limited to, a web browser, social networking applications, streaming media applications, games, mapping and location applications, electronic mail applications, financial applications, and the like. In a typical example, the end user typically uses one or more of the programs 4420 along with a network such as the system.

We claim:

1. A computer implemented digital platform comprising:
a. a digital client site selected from one of; a website or a mobile application, the client site comprising a digital agreement;
b. a GPS locator,
wherein the client site or the GPS locator may be accessed as combined or separate parts and wherein the client site allows an owner of a good or service to make real-time changes to the digital agreement and further allows a user to agree to a modified current digital agreement which then gives the user the right to access the good or service specified within the digital agreement.

2. The platform of claim 1, wherein the good or service comprises government owned or government managed lands selected from the group consisting of; hunting land, fishing area, hiking land, camping land, golfing land, swimming area, and lodging.

3. The platform of claim 2, wherein the government owned or managed hunting land is a Block Management Area.
